(19) United States
(12) Patent Application Publication
(10) Pub. No.: US 2019/0315167 A1
(43) Pub. Date: Oct. 17, 2019

(54) DEVICE FOR UNSEATING TIRE BEADS FROM RIMS

(71) Applicant: RD MALENFANT INC., Longueuil (CA)

(72) Inventor: Yvan Malenfant, Longueuil (CA)

(21) Appl. No.: 15/499,401

(22) Filed: Apr. 27, 2017

Related U.S. Application Data
(60) Provisional application No. 62/328,594, filed on Apr. 27, 2016.

(51) Int. Cl. B60C 25/13

(52) U.S. Cl. CPC B60C 25/13

(57) ABSTRACT

A device for unseating tire beads of a tire from a rim comprises a pair of substantially facing first and second jaws adapted to receive the tire substantially vertically therebetween and to be displaced relative to one another, and transversally of the tire, for exerting pressure on the tire sidewalls, adjacent the rim, such as to detach (unseat) the tire from the rim. Generally, one jaw remains in position while the other, i.e. mobile, jaw is displaced towards the tire sidewall, for instance by way of a pneumatic cylinder that displaces the mobile jaw towards the tire and the other jaw. The positions of at least one of the jaws can also be adjusted so as to accommodate tires and rims of different configurations, e.g. diameters, whereby the jaw(s) can be adjustably brought, prior to engaging the tire, to a location where the jaw(s) will ultimately engage the tire sidewall at a location close to the rim. This is typically done once the wheel has been positioned in the device and prior to causing the displacement of the mobile jaw via the actuated cylinder. The mobile jaw can be mounted on a pivotable parallelogram linkage. A mobile abutment unit is provided to provide support for the tire sidewall adjacent the other jaw, wherein the other jaw is located between the rim and the mobile abutment unit during the unseating operation of the tire from the rim.

### CROSS REFERENCE TO RELATED APPLICATIONS

This application claims priority on U.S. Provisional Application No. 62/328,594, now pending, filed on Apr. 27, 2016, which is herein incorporated by reference.

### FIELD

The present invention relates to wheels and, more particularly, to devices for detaching tires from rims.

### BACKGROUND

When it is required to remove a tire from a rim, it is a physically difficult task as over time the tires, i.e. the inner circular beads that define the tire's central opening, have “adhered” to the rims. This task is presently carried out with a sledgehammer, by repeatedly hitting the tire sidewall near the rim while the tire is laid on the ground. This method damages the rims, is physically demanding and there is a high risk of injuries.

Various devices have been proposed to detach the tire's beads from the rim onto which the tire is mounted. Other devices are used to then remove the tire from the rim. Regarding the devices for separating the tire's beads from the its rim, there are two main types of systems, namely hook-based systems that slide in to separate the tire bead from the rim by pulling the tire away from the rim, and bead breaker systems, which use a jaw pushed on the tire's sidewall to detach the tire bead from the rim.

Also known is the device of PCT Publication no. WO2014/066985, which is herein incorporated by reference.

Therefore, there is a need for a device for detaching a tire's beads from the rim carrying the tire.

### SUMMARY

It is therefore a present aim to provide a novel device for unseating tire beads from rims.

### BRIEF DESCRIPTION OF THE DRAWINGS

Reference will now be made to the accompanying drawings, showing by way of illustration an illustrative embodiment of the present invention, and in which:

FIGS. 1A and 1B are front and rear perspective views, respectively, of a device for unseating tire beads from rims according to one of various exemplary embodiments;

FIG. 2 is a parts' list for the device of FIGS. 1A and 1B;

FIG. 3 is an exploded view of the device;

FIGS. 4A, 4B and 4C show other views of the device;

FIG. 4D shows the device with a wheel thereon and positioned so that the device can unseat the tire from the wheel's rim;

FIGS. 5A, 5B and 5C show views of components of the device;

FIGS. 6A and 6B show variants V1 and V2, respectively, of a mobile jaw of the device;

FIG. 7A shows a structure (frame) of the device, and FIG. 7B is a parts' list thereof;

FIGS. 8A, 8B, 8C and 8D are views of a pivotable structure of the device, which includes a fixed jaw and which can be adjusted to accommodate various wheel and tire configurations and sizes, and FIG. 8E is a parts' list thereof;

FIGS. 9A, 9B, 9C and 9D are views of a mobile jaw of the device, and FIG. 9E is a parts' list thereof;

FIGS. 10A to 10E, FIGS. 11A to 11C and FIGS. 12A to 12C are views of variants of the mobile jaw, and FIGS. 10F, 11D and 12D are respective parts' list thereof;

FIGS. 13A, 13B, 13C, 13D, 13E, 13F, 13G, 13H and 13I are views of a spring-loaded pivotable support for the mobile jaw, and FIG. 13J is a parts' list thereof;

FIGS. 14A, 14B, 14C, 14D, 14E and 14F are views of a wheel support of the device, but with the two rollers thereof not being shown, and FIG. 14G is a parts' list thereof;

FIGS. 15A, 15B, 15C and 15D are views of a removable abutment unit of the device, and FIG. 15E is a parts' list thereof; and

FIGS. 16A, 16B, 16C, 16D and 16E are views of a manifold of the device, for the pneumatic components of the device.

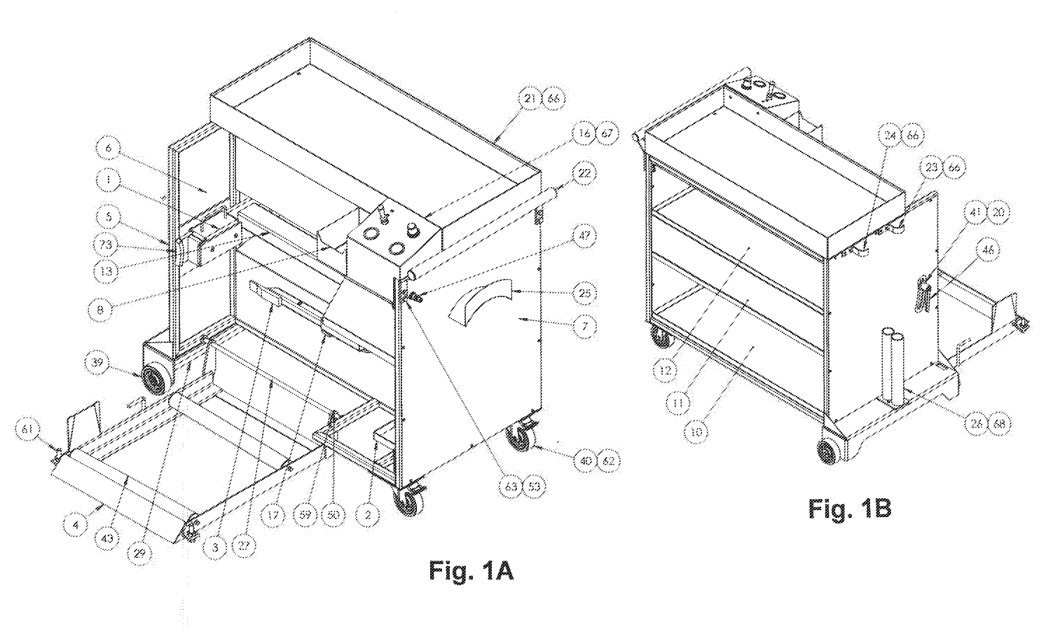

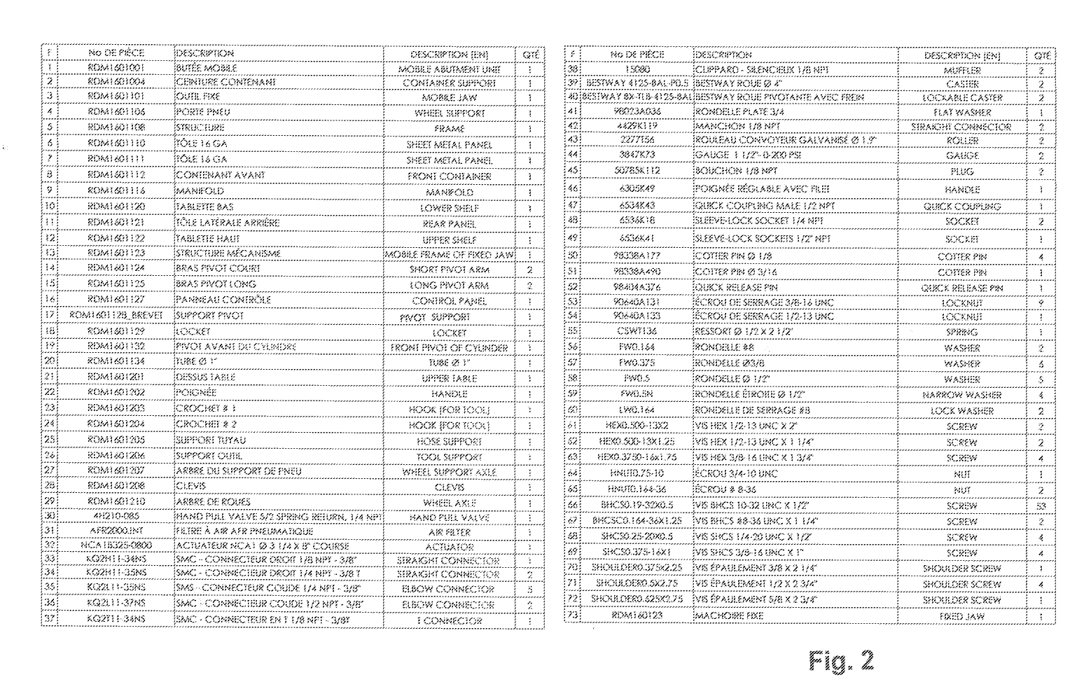

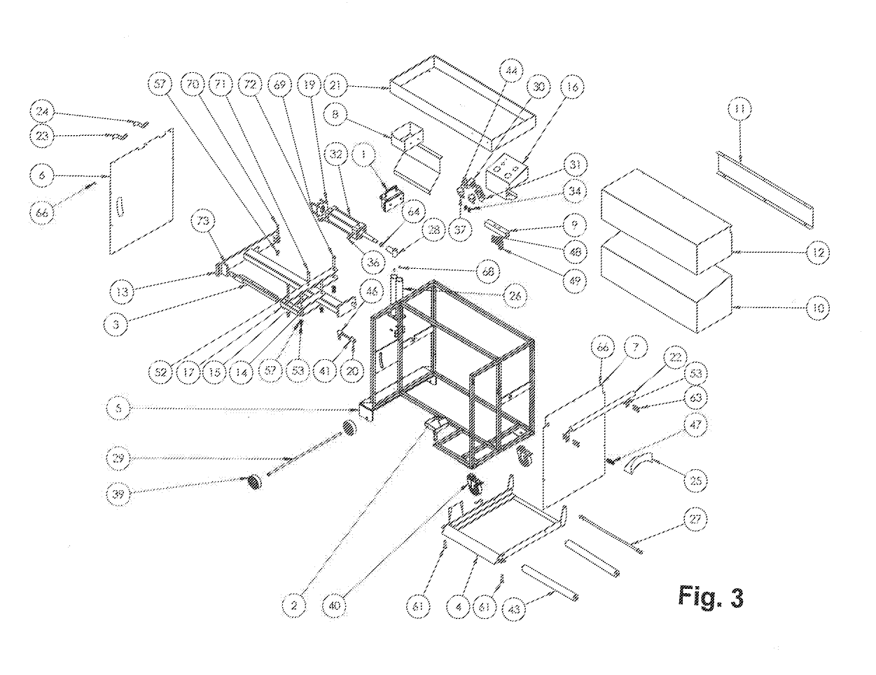

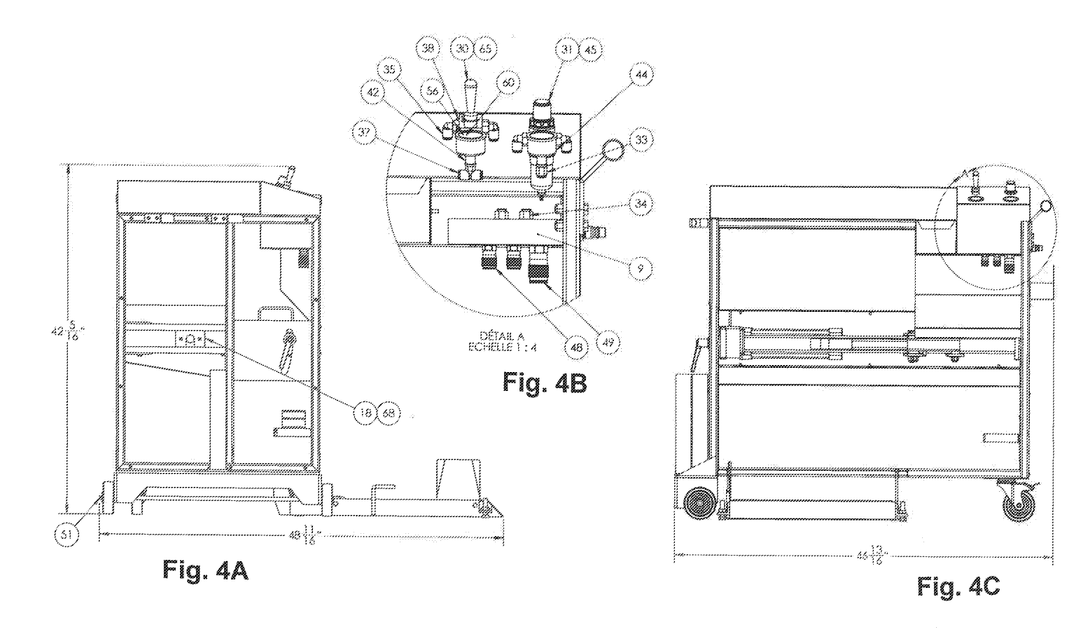

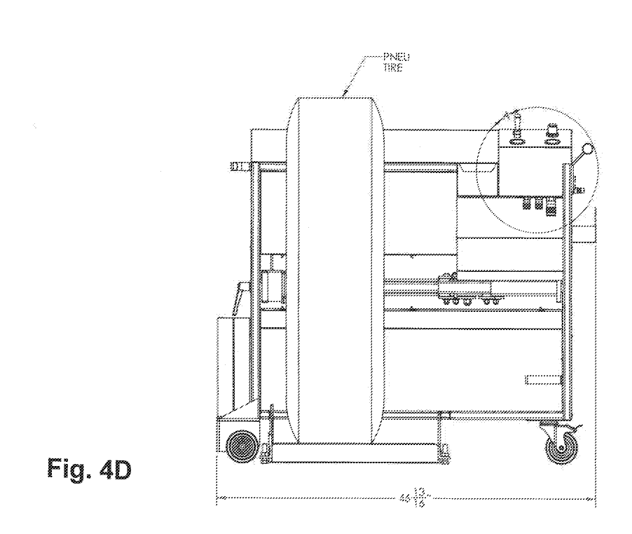

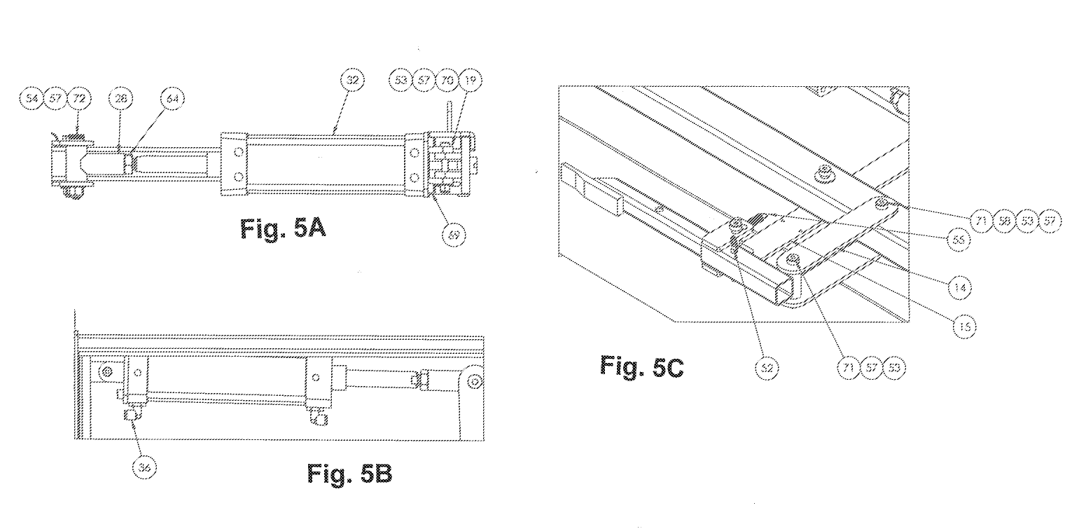

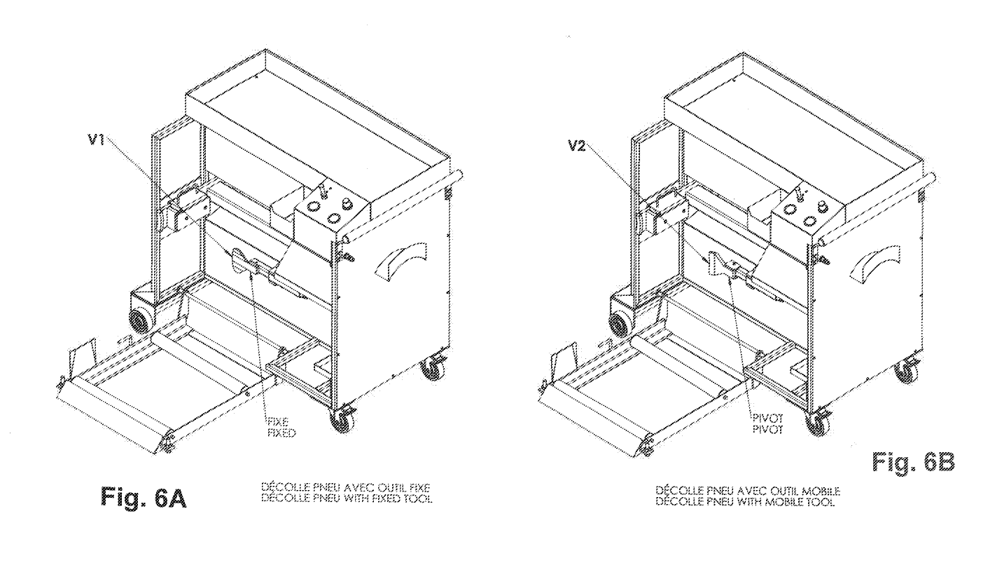

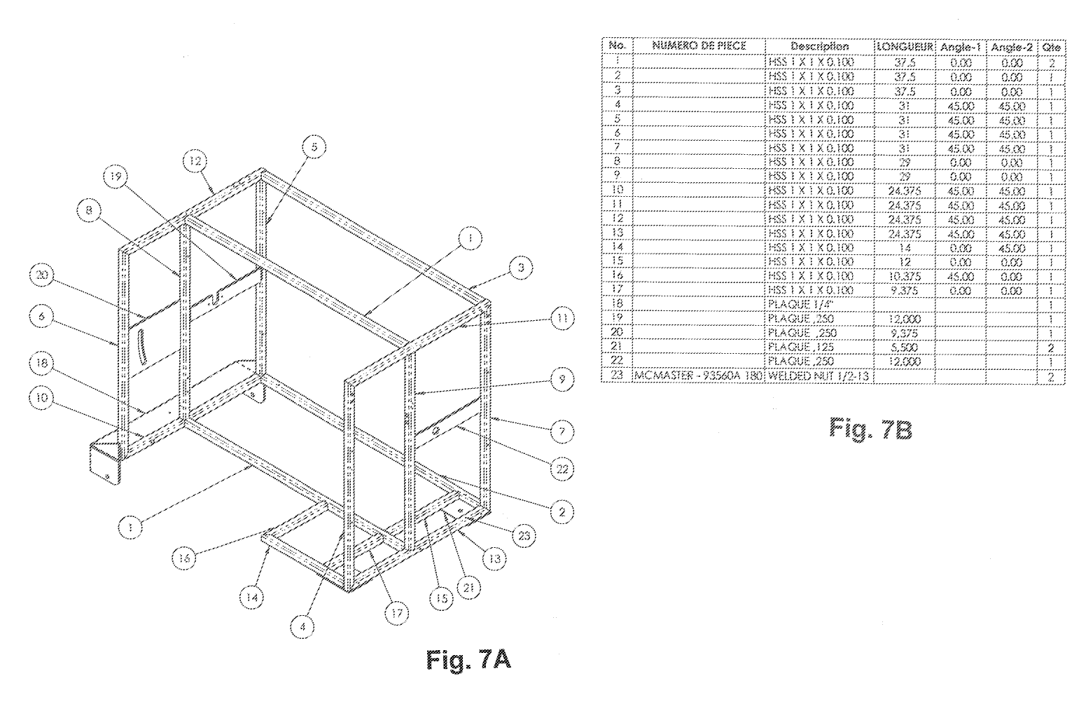

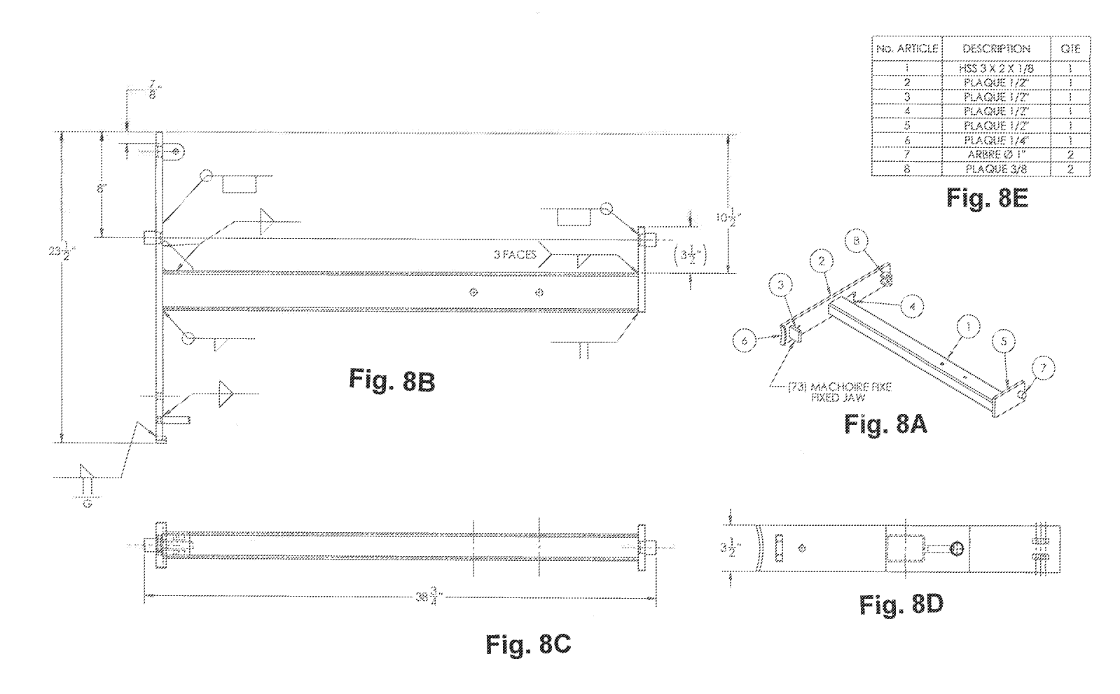

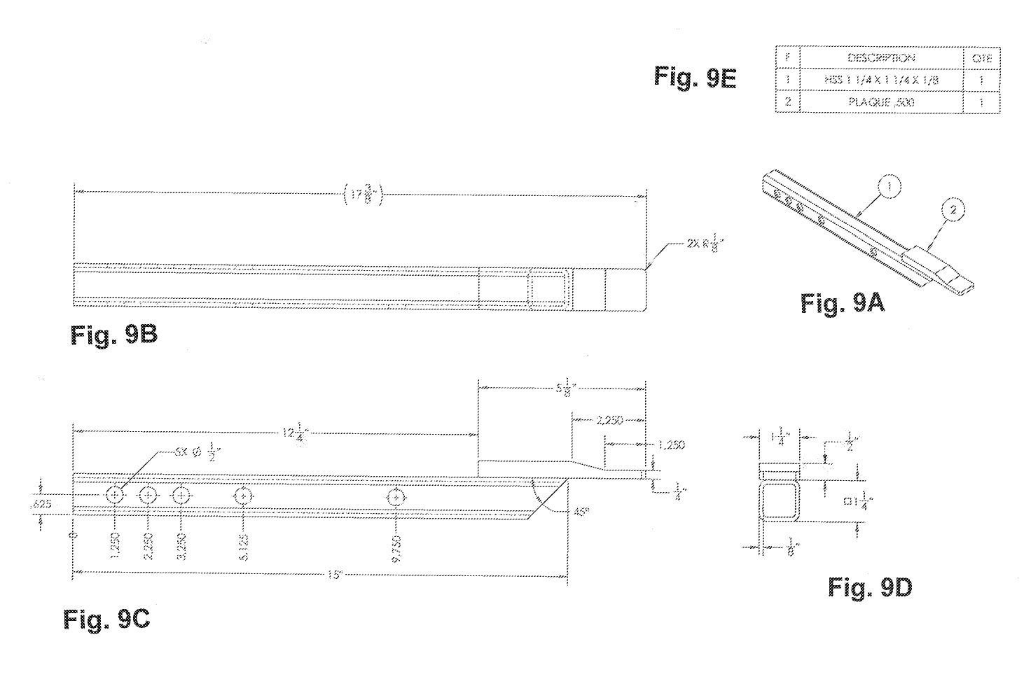

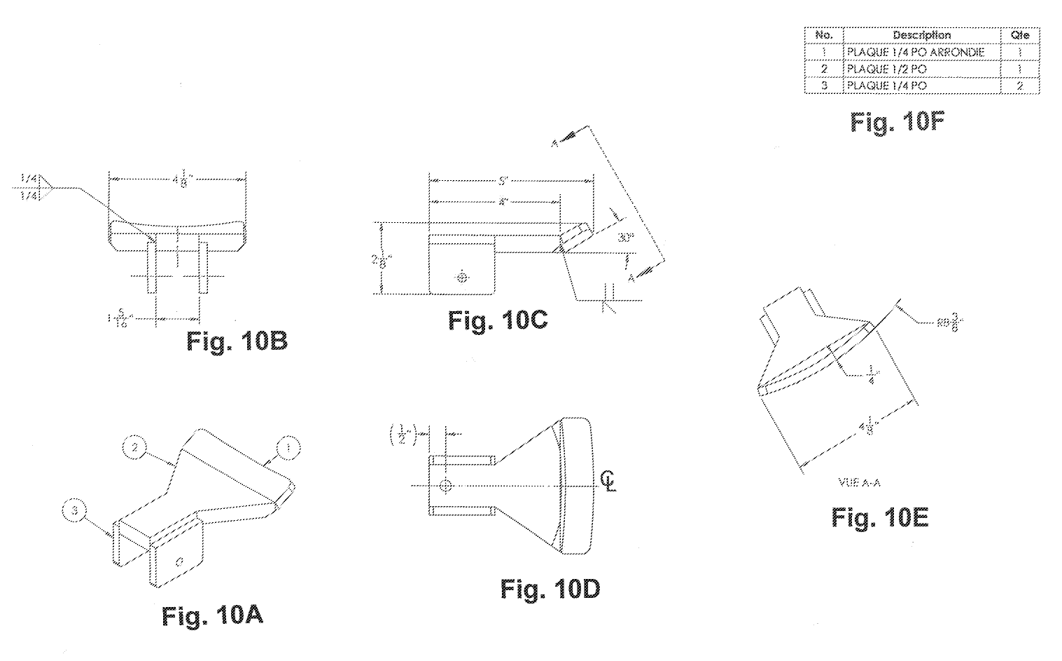

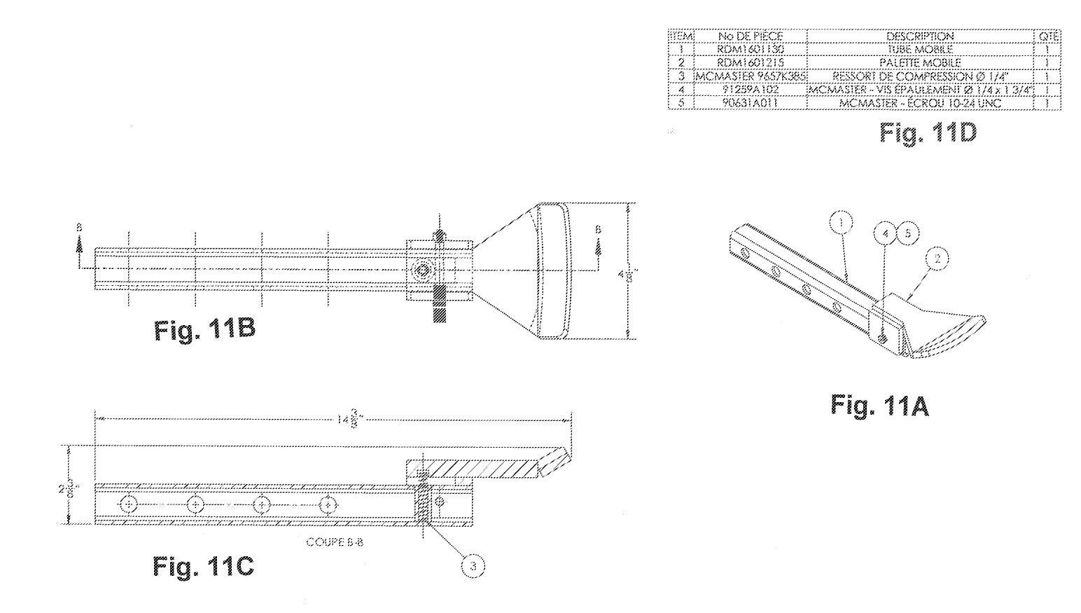

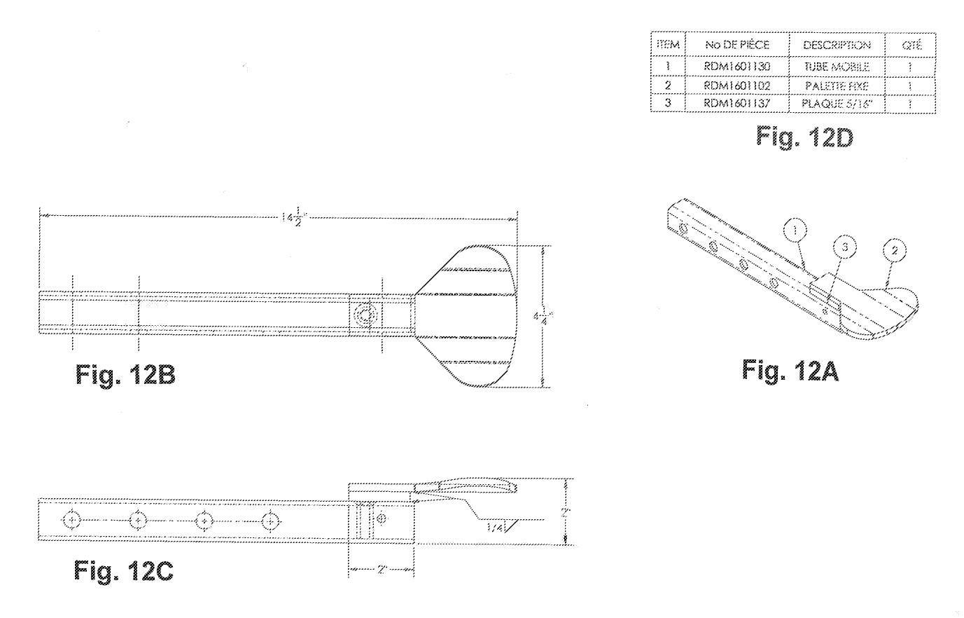

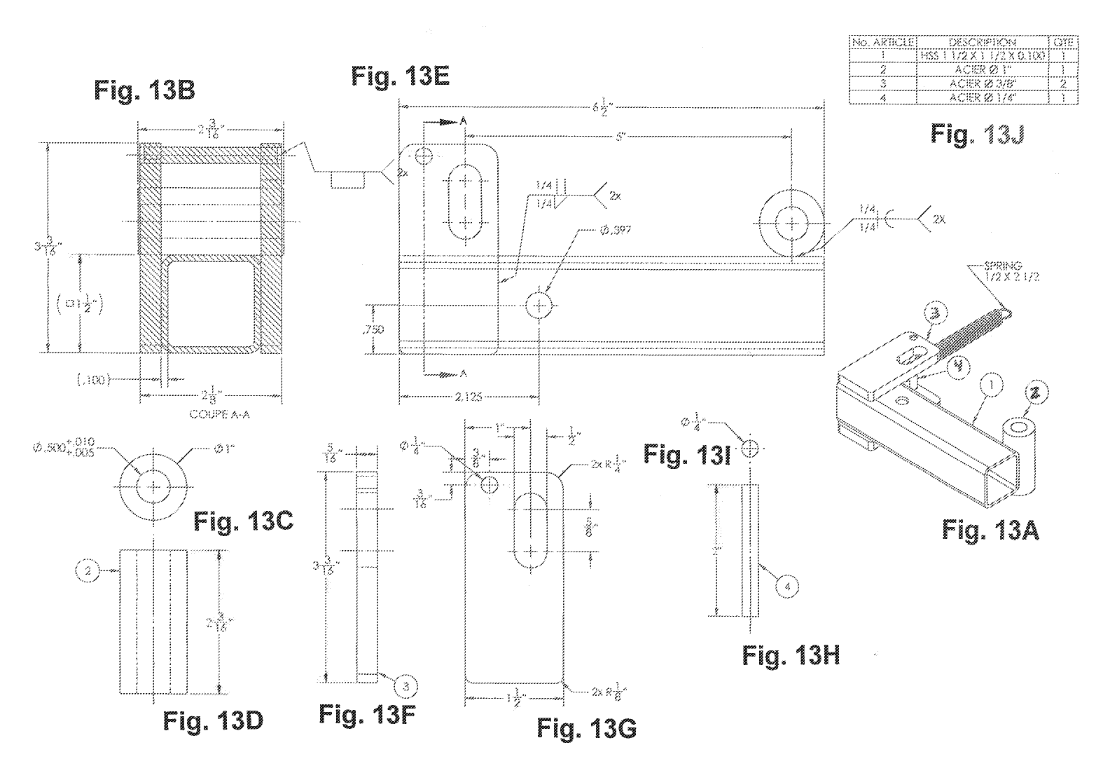

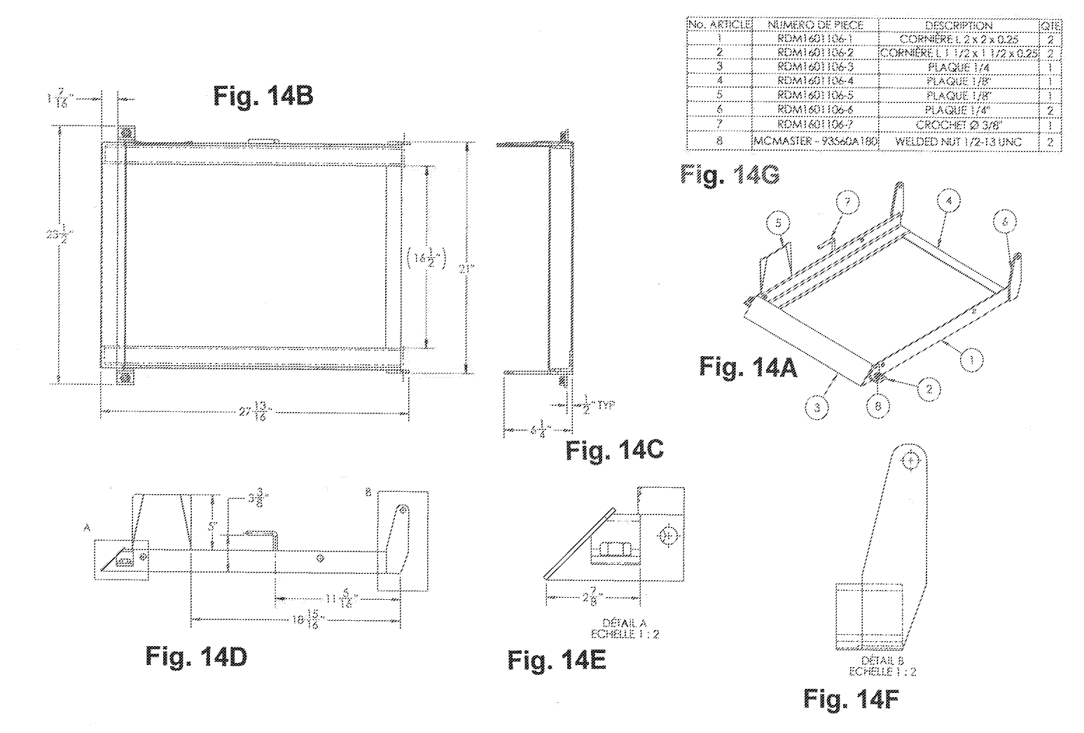

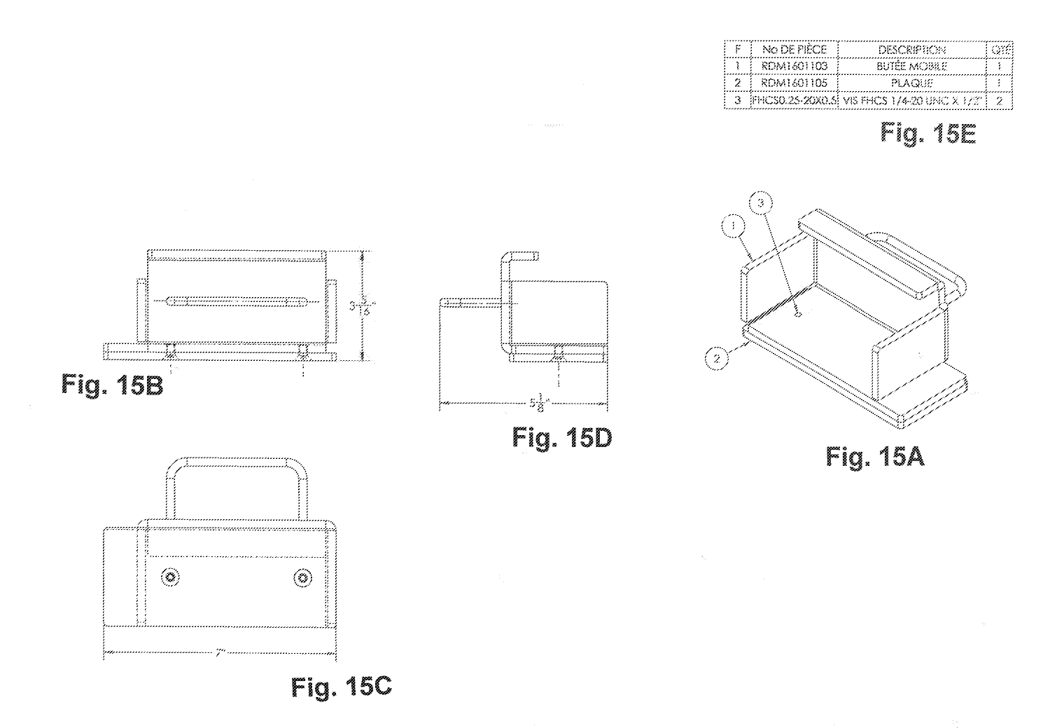

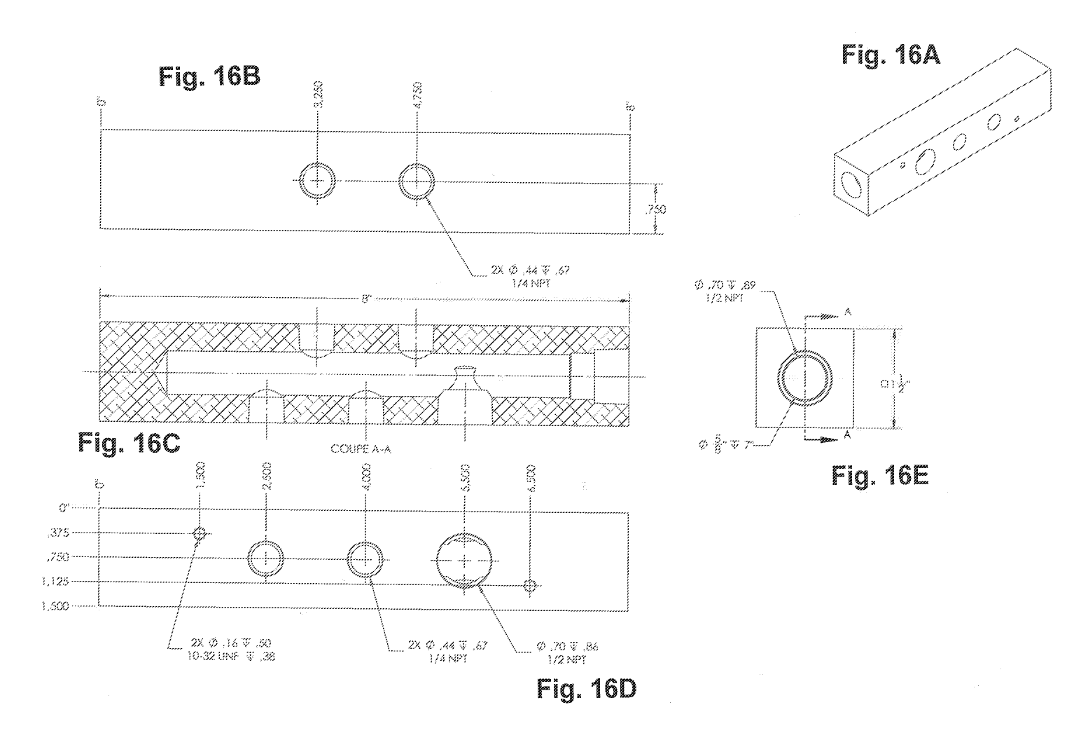

### DESCRIPTION OF ILLUSTRATIVE EMBODIMENTS

With reference to the enclosed drawings, a device for unseating beads of a tire from a rim onto which the tire is mounted is illustrated and herein described.

Basically, the wheel is rolled onto the wheel support 4, which is angled to steer the wheel towards the left side of the device, that is the side carrying the fixed jaw 73. This is achieved by having the rollers 43 appropriately angled.

Then the mobile jaw 3 is displaced towards the wheel via a pneumatic cylinder and an intermediate linkage. The unit 13 can be pivoted to accommodate various wheel and tire sizes and configurations, such that the jaws 3 and 73 can impact the tire sidewall close to the rim. The mobile jaw 3 detaches the right tire side from its rim, with the fixed jaw 73 also acting on the left tire side. In some instances, the wheel is flipped so that the mobile jaw 3 can act on the other tire side after having detached the right tire side.

The wheel support 4 is pivotable from its in-use position shown on Sheet No. 1 to a vertical storage position so that the device can then be displaced.

The retracted position of the mobile jaw 3 is adjusted so that it is close to the tire wall that the mobile jaw 3 will subsequently engage. This is so that the mobile jaw 3 generally displaces linearly even though the arms of the linkage may displace along an arc. The spring shown on Sheet No. 10 brings the mobile jaw 3 to its original position after it has been retracted.

The abutment unit 1, which is shown in isolation on Sheet No. 12, is sometimes used when the mobile jaw 3 has detached the right tire wall and the wheel is flipped over so that the mobile jaw 3 can act on the opposite tire wall. In such a case, the unit 1 is suspected near the fixed jaw 73, as seen on sheet No. 1, such that the detached tire wall is supported thereby while the mobile jaw 3 acts on the opposite tire wall.

Sheet No. 8 shows the pivotable structure that allows the positional adjustment of the jaws depending on the tire size.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the disclosure as defined in the claims appended hereto.

1. A device for unseating tire beads of a tire from a rim, comprising comprises a pair of substantially facing first and second jaws adapted to receive the tire therebetween and to be displaced relative to one another, and transversally of the tire, for exerting pressure on the tire sidewalls, adjacent the rim, such as to detach the tire from the rim.

2. The device according to claim 1, wherein there is provided a wheel support whereby the tire is received in the device in a substantially vertical position, with the jaws being provided on opposed sides of the tire.

3. The device according to claim 1, wherein during operation of the device for unseating the tire from the tire rim, the first jaw is a mobile jaw, whereas the second jaw remains stationary, with the mobile jaw being adapted to be displaced towards and away from the tire sidewall and the stationary jaw.

4. The device according to claim 3, wherein the mobile jaw is mounted on a parallelogram linkage which is operated via a pneumatic cylinder.

5. The device according to claim 1, wherein during positions of at least one of the jaws is adapted to be adjusted so as to accommodate tires and/or rims of different configurations, e.g. diameters, whereby the at least one jaw is adapted to be adjustably brought, prior to engaging the tire, to a location where the at least one jaw will engage the tire sidewall at a location close to the rim.

6. The device according to claim 5, wherein an adjustment of the at least one jaw is adapted to be carried once the wheel has been positioned in the device and prior to causing a relative displacement of the jaws.

7. The device according to claim 1, wherein a mobile abutment unit is provided to provide support for the tire sidewall adjacent one of the jaws, typically a stationary jaw, which is located between the rim and the mobile abutment unit during the unseating operation of the tire from the rim.
